(19) United States
(12) Patent Application Publication
(10) Pub. No.: US 2011/0045133 A1
(43) Pub. Date: Feb. 24, 2011

(54) METHOD OF PRODUCING A THERMIZED UNRIPENED CHEESE AND CHEESE OBTAINED

(75) Inventor: Olivier Furling, Sable sur Sarthe (FR)

Correspondence Address: SUGHRUE MION, PLLC, 2100 PENNSYLVANIA AVENUE, N.W., SUITE 800, WASHINGTON, DC, 20037, US

(73) Assignee: Fromageries Bel, Paris (FR)

(21) Appl. No.: 12/919,677

(22) PCT Filed: Feb. 24, 2009
(86) PCT No.: PCT/FR2009/050292

§ 371 Date: Nov. 12, 2010

(30) Foreign Application Priority Data
Feb. 28, 2008 (FR) 08 51283

(51) Int. Cl. A23C 19/076; A23C 19/045; A23C 19/082

(52) U.S. Cl. 426/39; 426/36; 426/582

(57) ABSTRACT

Method of producing a cheese, according to which:
a cheese curd is prepared;
from the cheese curd there is prepared an intermediate cheese body;
a first treatment at a temperature of from 40 to 90° C. is carried out on the cheese body;
a texturizing treatment is carried out at the temperature of the first treatment in order to obtain a textured body;
the textured body is subjected to a second heat treatment by ohmic heating at a temperature of from 80 to 140° C. for from 10 seconds to 5 minutes;
the body obtained is cooled to a temperature below 100° C. in order to obtain a cheese; and
the cheese is packaged.

The present invention relates to the production of an unripened cheese having an improved shelf life.

Unripened cheeses are a family of cheeses characterized by an acidic moist body of low mineralization and low cohesion, having an acidulated taste and creaminess. Such unripened cheeses are obtained by coagulation, preferably acid coagulation, of milk, followed by straining of the coagulum obtained. Very generally, such cheeses have not undergone a ripening step.

Among the unripened cheeses there are thermized unripened cheeses, which have undergone heat treatment before being packaged. There are also cream cheeses, which are obtained by heat treatment of fresh curd in the presence of stabilizers and/or texturizing agents such as gums. Finally, there are processed unripened cheeses, which are obtained by heat treatment of fresh curd or of unripened cheese in the presence of melting salts.

In order to produce such cheeses, fresh curds are first prepared by coagulating milk which, preferably, is first fat-standardized or skimmed or pasteurized or even homogenized in order to reduce the size of the fat globules. This milk can be treated using membrane concentration techniques in order to increase the yields by incorporating serum proteins into the curd. The curds are obtained by coagulating the milk by the action of coagulating enzymes or by acidification.

In general, coagulation by means of enzymes uses especially the chymosin present in the rennet coming substantially from the cows' stomachs, but other enzymes of vegetable or microbial origin can be used. The curds obtained after removal of some or all of the lactoserum are firm and have a pH close to neutral. These curds are called “rennet curds” and are used substantially to produce pressed bodies and soft bodies.

Acid coagulation is obtained by the action of lactic ferments and/or food-grade acids. The pH of the milk is then lowered to its isoelectric point, close to 4.7, which causes precipitation of the proteins. The curds are then obtained by removing the lactoserum by spontaneous drainage or by centrifugation. These curds are friable and have fresh or even slightly acidulated flavour notes, a characteristic of products belonging to the family of the unripened cheeses, including thermized unripened cheese.

The acid curds so obtained can be enriched with cream or not, depending on the end product that is to be produced.

A variant of the method of producing curds for unripened cheeses consists in reconstituting the curds by mixing and hydrating to the desired solids content a mixture of fat-standardized milk powder and/or milk protein concentrates and/or milk fats according to the desired final fat content in the end product. The mixture obtained is then seeded with microorganisms that generate fragrant compounds conferring a “fresh note” on the product at the optimum temperature for development of the seeded microorganisms. Once the desired flavour notes have been obtained, maturation is stopped by heat treatment or cooling (freezing) for later use. The advantage of this method is that production can be carried out outside the milk production area, especially in countries without milk production.

From the curds so obtained it is possible to produce different types of unripened cheese:
quark, tvorog, labneh (Middle-East and Balkans), Queso Blanco (South America), Petit-Suisse, cottage cheese, etc.

These products are obtained after simple cooling and, optionally, after mixing with flavouring ingredients and/or formed elements (fruits, vegetables, etc.).
thermized unripened cheeses, which are similar to the above products but have been produced by undergoing an additional step of thermization, in which they are maintained at a temperature of from 55 to 75° C. for from 30 to 60 seconds, this step being carried out after incorporation of cream, formed elements, flavourings and even stabilizers. Such products can be foamed.
cream cheeses, which are curds which have or have not been subjected to heat treatment (at 80° C. for a period of time of up to 20 minutes). In these products, salt and stabilizers and/or texturizing agents such as gums have been incorporated into the curd which has or has not been fat-standardized. After incorporation of these elements, the mixture is optionally subjected to heat treatment and homogenized and is then optionally flavoured with fruits, flavourings, vegetables, formed elements, etc. Such products can be packaged both hot and cold.
processed unripened cheeses, which are obtained from drained curd which has or has not been enriched with cream and which has been subjected to a melting process, that is to say heat treatment in the presence of melting salts, which cheeses are preferably packaged hot.

It is to be noted that all these unripened and thermized cheeses have undergone heat treatment at temperatures which always remain below 90° C., or even below 80° C., in order to maintain as many of the flavour characteristics as possible, which might be destroyed by treatment at a higher temperature given the fragility of the curds used.

The techniques of producing this family of product are widely described in the literature and especially in the book by FOX, P.: “Cheese Chemistry, Physics and Microbiology NC Elsevier (2004)—Vol. 2, pages 301-348).

The products of this family, which represent a considerable part of the world cheese market, are much appreciated by consumers. However, they have the disadvantage of a short shelf life which, even for heat-treated products, does not exceed three months. Furthermore, these products cannot be stored out of a refrigerator.

Accordingly, these products are poorly suited to consumption away from the home or in countries where there are no cooling systems.

In order to improve the shelf life of these products, it has been proposed to use preservatives. However, the use of such additives poses problems in terms of food safety and the image of the product.

It has also been proposed to increase the heat treatment temperature of the products in order to carry out a sterilization treatment. Unfortunately, the fragility of the curds and the unripened cheeses is such that these sterilization treatments result in losses of flavour and in the appearance of a cooked taste which limits the use of such treatments considerably. In particular, even for processed unripened cheeses, and unlike processed cheeses obtained from pressed bodies, heat treatments at temperatures greater than 90° C., or even greater than 80° C., have unacceptable effects on the taste qualities of the cheeses.

The fact that it is not possible to treat such cheeses at sufficiently high temperatures to ensure successful sterilization has the disadvantage of causing health risks, especially owing to the temperature resistance of pathogenic or potentially pathogenic microorganisms at the temperatures at which heat treatments of such cheeses are carried out. That is especially the reason why the shelf life is limited.

The object of the present invention is to remedy those disadvantages by proposing a means of producing a thermized unripened cheese, optionally of the cream cheese or processed unripened cheese type, which has an improved shelf life and can be stored out of a refrigerator for a significant period of time.

To that end, the invention relates to a method of producing a cheese, according to which a cheese curd is prepared,
from the cheese curd there is prepared an intermediate cheese body;
a first treatment at a temperature of from 40 to 90° C. is carried out on the cheese body (or cheese);
a texturizing treatment is carried out at the temperature of the first treatment in order to obtain a textured body;
the textured body is subjected to a second heat treatment by ohmic heating at a temperature of from 80 to 140° C. for from 10 seconds to 5 minutes;
the body obtained is cooled to a temperature below 100° C. in order to obtain a cheese; and
the cheese is packaged.

Preferably, the heat treatment by ohmic heating is carried out at a temperature above 105° C.

Preferably, the cheese curd is obtained by acid coagulation of milk.

Preferably, the cheese curd is obtained from fat- and protein-standardized milk.

In order to prepare the intermediate cheese body, the curd is drained in order to remove the lactoserum.

The curd can also be a curd reconstituted by mixing and hydrating protein concentrates and animal or vegetable fats.

Preferably, the protein concentrates are milk protein concentrates.

After draining of the curd, there can be added one or more additional ingredients selected from a fat such as cream, milk protein concentrates, flavouring substances, nutritional substances such as oligoelements, vitamins, and fermented milk products, in amounts below 50%.

The first treatment at a temperature of from 40 to 90° C. is, for example, an operation of mixing the drained curd and the additional ingredients at a temperature of from 40 to 50° C.

It is also possible to add to the intermediate cheese body one or more stabilizers or texturizing agents, for example gums, carrageenans, starch, in a proportion below 3%.

Finally, it is possible to add to the intermediate cheese body one or more melting salts.

This method permits the production of thermized unripened cheeses whose shelf life in a refrigerator, that is to say at from 4 to 6° C., can exceed 6 months and which can be stored partially out of a refrigerator for a period of time of up to three months, such cheeses having retained the organoleptic characteristics and, especially, the fresh taste of conventional thermized unripened cheeses.

The inventors have in fact found, wholly unexpectedly, that the use of heat treatment by ohmic heating on this family of products up to temperatures of 140° C. was possible without affecting their texture and while retaining the fresh taste which is characteristic of this type of cheese, and without creating a cooked taste.

The invention accordingly relates also to cheese having the organoleptic and textural characteristics of a thermized unripened cheese, which cheese is obtainable by the method according to the invention and has a shelf life in a refrigerator of greater than 6 months with, optionally, periods out of a refrigerator of up to 3 months.

The cheese can have the organoleptic and textural characteristics of a cheese of the cream cheese type, with a shelf life in a refrigerator of greater than 6 months with, optionally, periods out of a refrigerator of up to 3 months.

The cheese can also have the organoleptic and textural characteristics of a processed unripened cheese, with a shelf life in a refrigerator of greater than 6 months with, optionally, periods out of a refrigerator of up to 3 months.

The cheeses can be produced both from cow's milk and from goat's milk, ewe's milk, buffalo milk, or milk from any other species of animal reared for that purpose, to which there can be added fat, which can be of milk origin but also of vegetable origin (colza oil, sunflower oil, soybean oil, olive oil, etc.). The cheeses have a solids content greater than 20% and a fat content of from 0 to 75% (expressed as fat in dry matter).

The invention will now be described, in a more precise but non-limiting manner, with reference to the accompanying figures, in which:

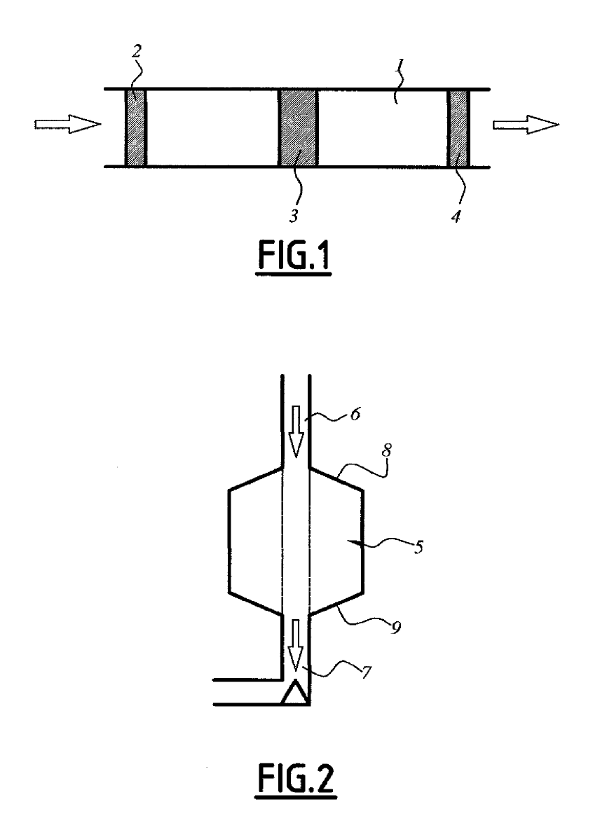

FIG. 1 shows, schematically, a chamber for treating cheese by ohmic heating in continuous mode;

FIG. 2 shows, schematically, a chamber for treating cheese by ohmic heating in a discontinuous mode;

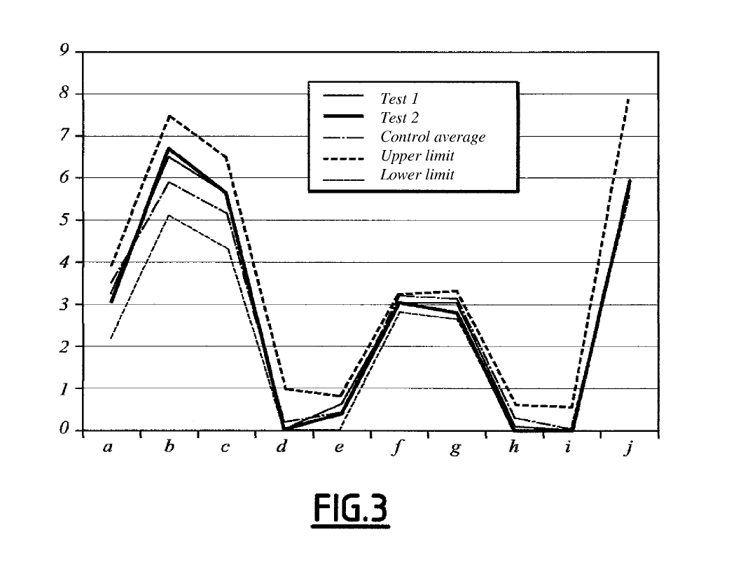

FIG. 3 is a sensorial profile over two tests of cooking of a processed unripened cheese by ohmic heating.

In order to produce a thermized unripened cheese according to the invention, a cheese curd is first prepared by coagulation of fat- and protein-standardized milk. In a known manner, the coagulation can be carried out either enzymatically, especially with the aid of chymosin or any other enzyme causing coagulation of the milk, such as enzymes of vegetable or microbial origin, or, preferably, by the action of food-grade acid such as lactic acid and/or by action of lactic ferments. The second embodiment is preferred because it aids the generation of fragrant compounds. The ferments used are the ferments conventionally used in cheese making or in the production of fermented milk products, especially:
lactobacilli, such as Lactobacillus acidophilus, Lactobacillus helveticus and Lactobacillus delbruecki lactis, or bulgaricus, Lactobacillus casei, Lactobacillus plantarum;
streptococci, such as Streptococcus thermophilus;
lactococci, such as Lactococcus lactis or Lactococcus cremoris;
leuconostocs.

These bacteria ensure the acidification necessary to obtain the isoelectric point of milk (pH=4.7), at which coagulation occurs. They also ensure the formation of fragrant compounds characteristic of unripened cheeses (acetoin, diacetyl, acetaldehyde, etc.).

Furthermore, additional nutritional advantages can be imparted to the end product by additionally also using bacteria having a probiotic effect, such as Lactobacillus reuteri or bifidobacteria.

After coagulation, the lactoserum is removed from the resulting coagulum, for example by spontaneous draining, optionally accelerated by mechanical means, or by centrifugation. It is further possible to add a number of additives and thus obtain an intermediate cheese body which will be described in greater detail hereinbelow. According to whether the cheese body is constituted solely of drained coagulum or has been provided with various additives, the intermediate cheese body permits the obtainment of a simple thermized unripened cheese, a cream cheese or a processed unripened cheese.

It will be noted that, as indicated hereinbefore, the curd can be a reconstituted curd obtained by mixing protein concentrate, preferably milk concentrate, and animal or vegetable fats.

In all cases, the intermediate cheese body is subjected to heat treatment in an exchanger at a temperature below 90° C., preferably below 80° C. or even below 60° C. The product so treated is optionally homogenized. The exchanger used is, for example, a scraped-surface heat exchanger.

In a particular embodiment, the heat treatment is heating below 50° C.

In a second preferred embodiment, the heat treatment is substantially mixing, at a temperature of from 40° C. to 50° C., of the curd obtained by draining and of the various additives which are added to produce the intermediate cheese body.

In all cases, the product obtained in the preceding step is subjected to a texturizing operation at the same temperature as the temperature of the preceding treatment. The purpose of this texturizing operation is to adjust the viscosity of the body.

The product so obtained is then transferred to a reactor for treatment by ohmic heating, where it is subjected to heat treatment at a temperature of from 90° C. to 145° C. for a period of from 10 seconds to 5 minutes. Preferably, this heat treatment is carried out at a temperature above 105° C., more preferably above 110° C. Heat treatment by ohmic heating has the advantage of yielding a cheese which has textural and organoleptic characteristics similar to those of a thermized unripened cheese, of a cream cheese or of a pre-processed cheese and which, further, has no residual flora and accordingly has a prolonged shelf life during which it retains its qualities, especially a fresh flavour note. Moreover, the cheese retains good food safety by removal of the pathogenic or potentially pathogenic bacteria.

The heat treatment by ohmic heating is a heat treatment for cheese which is known per se and is conventionally used for carrying out a pasteurization treatment. This treatment is carried out in continuous heat treatment installations, as shown in FIG. 1, or in heat treatment installations permitting treatment to be carried out discontinuously, as shown in FIG. 2.

In order to carry out a continuous heat treatment, the installation shown in FIG. 1 comprises a tubular chamber 1 which has three annular electrodes 2, 3 and 4. Two annular electrodes 2 and 4 are connected to neutral and one annular electrode 3 is connected to one phase of a three-phase power supply.

When the cheese body flows through the annular chamber and the electrodes are connected to a power source, an electric current flows through the cheese body between the different electrodes. This flow of electric current causes the cheese body to be heated by the joule effect. This electric heating has the advantage of taking place homogeneously in the mass, which avoids the overheating which is observed in conventional heating installations. As a result, the body can be heated uniformly at relatively high temperatures without the occurrence of organoleptic faults (cooked taste) associated with areas of overheating (along the walls, for example).

In the second embodiment, shown in FIG. 2, the cheese is introduced into a vertical chamber 5 which has a cheese body inlet through the upper portion 6 and an outlet through the lower portion 7. In its upper portion, the heating chamber 5 comprises a first electrode constituting a nozzle 8, and in its lower portion it has a second electrode forming a receptacle 9. When the cheese body arrives in the chamber, the diameter of which is greater than that of the channels for supplying and removing the cheese body, an electric current passes through the cheese body and heats it homogeneously. Heat treatments are thus obtained which have the same qualities as those obtained with the aid of continuous treatment installations.

Such installations for the ohmic heating of cheese can also include devices of the dynamic mixer type, which have the advantage of homogenizing the product in terms of temperature in a section of the installation.

After the operation of heat treatment by ohmic heating, the cheese body obtained is cooled to the packaging temperature by a flash-type device known per se or in a conventional heat exchanger. Before packaging, the cheese body can optionally be subjected to an additional texturizing treatment in order to adjust the final viscosity. In all cases, the cheese body is then packaged, for example in portions wrapped in aluminium or in trays or in pots or in any other suitable packaging.

As indicated hereinbefore, depending on the mode of preparation of the intermediate cheese body, there is obtained either a thermized unripened cheese or a cream cheese or a processed unripened cheese.

In order to produce thermized unripened cheese, the curd, after drainage of the coagulum, is optionally enriched with cream or another fat according to the desired fat content of the end product. There can optionally further be introduced milk protein concentrates (caseins, caseinates, etc.), flavouring substances, nutritional substances such as oligoelements, vitamins, or even fermented milk products, such as yoghurts, kefir, labneh or other known fermented products. The total of these additions can be up to 30% by weight of the finished product. The addition of these products can be useful for adjusting especially the organoleptic characteristics of the end product and, in particular, for imparting a fermented product note thereto.

In order to produce cheeses of the cream cheese type, stabilizers or texturizing agents, such as gums (guar gum, xanthan gum), carrageenans, starch, are also incorporated into the intermediate cheese body. These additives are added in amounts of less than 3% and preferably less than 1% by weight of the end product.

In order to produce cheeses of the processed unripened cheese type, melting salts are additionally incorporated into the intermediate cheese body as defined hereinbefore, in amounts of less than 3%, preferably less than 2%. The melting salts are salts conventionally used in the production of processed cheese, for example polyphosphates or sodium, potassium or magnesium citrates.

The invention will now be illustrated with the aid of examples.

### EXAMPLE 1

### Method of Producing Thermized Unripened Cheese

There is prepared an acid curd obtained by lactic fermentation at a temperature of 25° C. with the aid of a lactobacilli/streptococci mixture in an amount of 5.10⁶ cfu/g until a pH of 4.7 is obtained, which is the isoelectric point of casein. Coagulation of the milk occurs as a result.

The lactoserum is then removed by centrifugation at 25° C. The curd obtained is enriched with cream in order to obtain a product having a solids content of 35% and a fat content, expressed as fat in dry matter, of 60%. Mixing is carried out at a temperature of 45° C. in a scraped-surface heat exchanger, followed by a texturizing operation at the same temperature.

The product obtained is then subjected to heat treatment for 2 minutes at a temperature of 120° C. using an ohmic heating device comprising in the heating zone a mixer having a speed of rotation of 250 rpm.

The product is then cooled by flash cooling to a temperature of 90° C., and then it is sent to a high-pressure homogenizer (250 bar).

The cheese obtained is then packaged while hot (80° C.) and then cooled in a refrigerator.

The thermized unripened cheese so obtained was presented for tasting to a panel of experts, who indicated that the cheese obtained remained within the field of unripened cheeses without any fault in terms of texture (in particular, it is not floury), the texture of the products being similar to that of an unripened cheese produced in the conventional manner by treatment of the curd in a cutter at a temperature of 85° C. Furthermore, it was noted that the physico-chemical properties (rheological properties) were identical to that type of product.

Penetrometry tests were further conducted on a TA×T2. The results of these tests are shown in Table 1. They were conducted by applying the following protocol:
cylindrical probe having a diameter of 6 mm;
point speed: descent: 0.5 mm/s, ascent: 1 mm/s;
penetration distance: 10 mm;
test temperature: 9° C.

TABLE 1
Result of the penetrometry test:

| Sample | Force (N) | Area (N.s.) |
|---|---|---|
| Control | 0.55 | 9.22 |
| Cheese according to the invention | 0.49 | 8.35 |

It will be noted from these results that the differences between the control, which was produced at a low temperature in a cutter according to conventional techniques for producing thermized unripened cheese, and the results obtained with the cheese produced according to the invention, with heat treatment at 120° C. by ohmic heating, are very small. Furthermore, it will be noted that the textures of the two products are very comparable.

The cheeses so obtained can be stored out of a refrigerator for a relatively long period of up to six months.

### EXAMPLE 2

### Method of Producing a Processed Unripened Cheese (First Embodiment)

There is prepared a curd identical to that of the preceding example, enriched with cream in order to obtain a solids content of 45% and a fat content of 70%, expressed as fat in dry matter.

A flavour, for example a strawberry flavour, is introduced into the curd, and 1% melting salt in the form of a polyphosphate/sodium citrate mixture is added.

The mixture obtained is then subjected to a first heat treatment operation at 90° C. for 5 minutes, with shear, in a cutter-type cooker having a speed of rotation of from 750 to 3000 rpm.

This cooking operation is followed by a texturizing operation in an oven for 15 minutes, with gentle stirring, at a temperature of 80° C.

Following the texturizing, the cheese undergoes a second treatment at 130° C. for one minute by passage through an ohmic heating cell, and the product obtained is then cooled to 90° C. by flash cooling and then packaged at that temperature in the form of a portion wrapped in aluminium.

The cheese so obtained was presented for tasting to a panel of experts, who compared it with control products which had been obtained by a single heat treatment at 90° C. followed by a texturizing treatment but had not undergone high-temperature heat treatment. As shown in the table below, the experts did not find any difference in terms of taste and texture between the cheese produced according to the invention and the cheeses given by way of example. In particular, they found that the products treated by ohmic heating had the characteristics of a creamy taste and texture which can be found in the controls treated at 90° C.

TABLE 2

| | Taste | Texture |
|---|---|---|
| Sample | (rated out of 5) | (rated out of 5) |
| Pre-processed control | 4.5 | 4.5 |
| Product treated at 130° C. (invention) | 4.5 | 4.75 |

Further, texture measurements were carried out by penetrometric tests according to the same operating protocol as in the preceding example, and the results recorded in Table 3 were obtained.

TABLE 3

| | | Unripened/processed treated |
|---|---|---|
| | Unripened/processed | by ohmic heating (cooking at |
| Penetrometry | Control (cooking at 90° C.) | 130° C.) |
| Maximum | 2.32 | 2.57 |
| force (N) | | |

The penetrometry results are similar for the control products and the cheeses treated at high temperature by ohmic heating. It is accordingly found that the ohmic heating treatment, which allows the product to be made safe in microbiological terms, in particular enables the original organoleptic characteristics of the product to be retained relative to a control treated at 90°.

The cheeses so obtained can be stored out of a refrigerator for a relatively long period of up to six months.

### EXAMPLE 3

### Method of Producing Processed Unripened Cheese (Second Embodiment)

There is prepared a mixture of curd, cream and flavouring ingredients (garlic, fine herbs) and melting salts identical to that of the preceding example, and these elements are mixed in a cutter at 45° C. with stirring corresponding to a speed of rotation of 1500 rpm for 2 minutes. The mixture so obtained is sent directly to an ohmic heating reactor, where it undergoes heat treatment at a temperature of 115° C. for 30 seconds.

The product treated in the ohmic heating installation is then cooled to 95° C. by flash cooling and then subjected to a step of hot texturizing at 90° C. in an oven, packaged in portions and cooled to 4° C. by passage through a refrigerating tunnel. The cheese so obtained was also presented to a panel of experts for evaluation of the sensorial characteristics of the products. The experts compared the products obtained by two successive tests, which were compared with a reference processed unripened cheese such as that described in Example 2. The results of these tests are shown in FIG. 3, in which there are given the results of the first test, the results of the second test, the upper and lower limits for each of the sensorial characteristics, which are the limits of acceptability of the product. Finally, the average values obtained for a control cheese.

In the figure, the various sensorial characteristics are as follows:

a) colour;
b) firmness;
c) pasty;
d) floury;
e) fatty;
f) salty;
g) acidic;
h) bitter;
i) lactic;
j) diacetyl.

In addition, the products were tested after storage for 8 weeks out of a refrigerator, while being kept at 37° C. In these tests, a control sample of cheese according to the prior art and a sample of cheese according to the invention were compared.

The results are shown in the following table, where there were measured, at the end of one week, two weeks, four weeks and eight weeks, the change in the solids content (ES), the pH, the total flora, the anaerobigazogenic flora spores (SAG), the sulfito-reducing flora (SR), bacillus spores and Bacillus cereus (ES expressed as g/100 g and flora in cfu/g).

TABLE 4

| | | | Total | | | Bacillus | Bacillus |
|---|---|---|---|---|---|---|---|
| Control | ES | pH | flora | SAG | SR | cereus | spores |
| s + 1 | 47.1 | 5.34 | 110 | <3 | 0 | 20 | <10 |
| s + 2 | 47.3 | 5.33 | 47000 | <3 | 2 | 50 | <10 |
| s + 4 | 47.7 | 5.22 | 160000 | 4 | 0 | 20 | <10 |
| s + 8 | 47.9 | 4.91 | <10 | <3 | 0 | 10 | <10 |

TABLE 5

| Test | | | Total | | | Bacillus | Bacillus |
|---|---|---|---|---|---|---|---|
| (110° C.) | ES | pH | flora | SAG | SR | cereus | spores |
| s + 1 | 47.9 | 5.29 | 30 | <3 | 0 | <10 | <10 |
| s + 2 | 48.6 | 5.3 | 10 | <3 | 0 | <10 | <10 |
| s + 4 | 49.5 | 5.32 | 560 | <3 | 0 | <10 | <10 |
| s + 8 | 49.5 | 5.25 | <10 | <3 | 0 | <10 | <10 |

These tests of storage at a temperature of 37° C. permit the simulation of storage of the products out of a refrigerator, knowing that storage for 8 weeks at 37° C. can be assimilated to storage for a longer period equivalent to 5 to 6 months at 4-5° C. They show that the heat treatment according to the invention allows the total flora to be reduced significantly during storage, and enables the potentially pathogenic contaminating flora of the bacilli to be reduced. This reduction in potentially pathogenic flora allows the products to be stored out of a refrigerator for a relatively long period of up to 6 months.

The similarity in total flora between the control and the test at 8 weeks is explained by the difference in pH. The increase in the acidity of the control causes inhibition of the development of the flora but a deterioration in the organoleptic characteristics (products which become increasingly acidic no longer correspond to the same group of products and become uneatable after 6 months' storage), contrary to the test in which the pH does not change.

1-14. (canceled)

15. Method of producing a cheese, according to which:
a cheese curd is prepared;
from the cheese curd there is prepared an intermediate cheese body;
a first treatment at a temperature of from 40 to 90° C. is carried out on the cheese body;
a texturizing treatment is carried out at the temperature of the first treatment in order to obtain a textured body;
the textured body is subjected to a second heat treatment by ohmic heating at a temperature of from 80 to 140° C. for from 10 seconds to 5 minutes;
the body obtained is cooled to a temperature below 100° C. in order to obtain a cheese; and
the cheese is packaged.

16. Method according to claim 15, wherein the heat treatment by ohmic heating is carried out at a temperature above 105° C.

17. Method according to claim 15, wherein the cheese curd is obtained by acid coagulation of milk.

18. Method according to of claim 15, wherein the cheese curd is obtained from fat- and protein-standardized milk.

19. Method according to claim 15, wherein, in order to prepare the intermediate cheese body, the curd is drained in order to remove the lactoserum.

20. Method according to claim 15, wherein the curd is a curd reconstituted by mixing and hydrating animal or vegetable protein and fat concentrates.

21. Method according to claim 20, wherein the protein concentrates are milk protein concentrates.

22. Method according to claim 19, wherein, after draining of the curd, there are added one or more additional ingredients selected from a fat such as cream, milk protein concentrates, flavouring substances, nutritional substances such as oligoelements, vitamins, and fermented milk products, in amounts below 50%.

23. Method according to claim 22, wherein the first treatment at a temperature of from 40 to 90° C. is an operation of mixing the drained curd and the additional ingredients at a temperature of from 40 to 50° C.

24. Method according to claim 19, wherein there are added to the intermediate cheese body one or more stabilizers or texturizing agents, for example gums, carrageenans, starch, in a proportion below 3%.

25. Method according to claim 19, wherein one or more melting salts are added to the intermediate cheese body.

26. Cheese having the organoleptic and textural characteristics of a thermized unripened cheese, wherein the cheese it is obtainable by the method according to claim 19 and wherein the cheese has a shelf life in a refrigerator of greater than 6 months with, optionally, periods out of a refrigerator of up to 3 months.

27. Cheese having the organoleptic and textural characteristics of a cheese of the cream cheese type, wherein the cheese is obtainable by the method according to claim 24 and wherein the cheese has a shelf life in a refrigerator of greater than 6 months with, optionally, periods out of a refrigerator of up to 3 months.

28. Cheese having the organoleptic and textural characteristics of a processed unripened cheese, wherein the cheese is obtainable by the method according to claim 25 and wherein the cheese has a shelf life in a refrigerator of greater than 6 months with, optionally, periods out of a refrigerator of up to 3 months.
